(19) United States
(12) Patent Application Publication
(10) Pub. No.: US 2026/0320172 A1
(43) Pub. Date: Oct. 15, 2026

(54) ACCOUNT MANAGEMENT SERVER, NON-TRANSITORY COMPUTER-READABLE RECORDING MEDIUM, AND ACCOUNT MANAGEMENT METHOD

(71) Applicant: KYOCERA DOCUMENT SOLUTIONS INC., OSAKA (JP)

(72) Inventor: SATOSHI IMAI, OSAKA (JP)

(21) Appl. No.: 19/636,875

(22) Filed: Apr. 1, 2026

(30) Foreign Application Priority Data
Apr. 14, 2025 (JP) 2025-066092

(51) Int. Cl. G06F 21/45; G06F 16/335

(52) U.S. Cl. CPC G06F 21/45; G06F 16/337

(57) ABSTRACT

An account management server includes an account creating section, a user ID determining section, a cancellation determining section, a suspicious operation counting section, and an account creation stopping section. The account creating section displays a user ID input screen on a client apparatus, and performs account creating processing using a user ID input to the user ID input screen. The user ID determining section determines whether the user ID input by a user to the user ID input screen exists. When the user ID does not exist, the cancellation determining section determines that account creation has been canceled by the user on a next item input screen. The suspicious operation counting section increments a suspicious operation count when account creation has been canceled on the next item input screen. When the count exceeds a reference value, the account creation stopping section stops the account creation for a specified time period.

### CROSS-REFERENCE TO RELATED PATENT APPLICATION

This application claims the benefit of Japanese Priority Patent Application JP 2025-066092 filed Apr. 14, 2025, the entire contents of which are incorporated herein by reference.

### FIELD OF THE DISCLOSURE

The present disclosure relates to an account management server that can prevent an account from being created illegally, a non-transitory computer-readable recording medium that has recorded therein an account management program, and an account management method.

### BACKGROUND OF THE DISCLOSURE

When user accounts are created in Web services, users are requested to input unique IDs such as user names or email addresses. It is necessary that the IDs have unique values in order to identify the users. Thus, a UI that displays thereon an error indication to encourage a user to input a different ID again when an already used ID is input is commonly used.

At this point, it becomes clear that the input ID is an already existing ID. This may result in a malicious user trying an illegal access using this ID and any password in combination.

### SUMMARY OF THE DISCLOSURE

An account management server according to an embodiment of the present disclosure includes an account creating section, a user ID determining section, a cancellation determining section, a suspicious operation counting section, and an account creation stopping section. The account creating section displays a user ID input screen on a client apparatus, and performs an account creating process on the basis of a user ID input to the user ID input screen. The user ID determining section determines whether the user ID input by a user to the user ID input screen exists. When the user ID does not exist, the cancellation determining section determines that account creation has been canceled by the user on a next item input screen. The suspicious operation counting section increments a suspicious operation count when the account creation has been canceled on the next item input screen. When the suspicious operation count exceeds a reference value, the account creation stopping section stops the account creation by the client apparatus for a specified period of time.

An account management program according to an embodiment of the present disclosure that has been recorded in a non-transitory computer-readable recording medium causes a control circuit of an account management server to operate as an account creating section, a user ID determining section, a cancellation determining section, a suspicious operation counting section, and an account creation stopping section. The account creating section displays a user ID input screen on a client apparatus, and performs an account creating process on the basis of a user ID input to the user ID input screen. The user ID determining section determines whether the user ID input by a user to the user ID input screen exists. When the user ID does not exist, the cancellation determining section determines that account creation has been canceled by the user on a next item input screen. The suspicious operation counting section increments a suspicious operation count when the account creation has been canceled on the next item input screen. When the suspicious operation count exceeds a reference value, the account creation stopping section stops the account creation by the client apparatus for a specified period of time.

An account management method according to an embodiment of the present disclosure is performed by an account management program being executed by a control circuit of an account management server. The account management method includes displaying a user ID input screen on a client apparatus, and performing an account creating process on the basis of a user ID input to the user ID input screen. It is determined whether the user ID input by a user to the user ID input screen exists. When the user ID does not exist, it is determined that account creation has been canceled by the user on a next item input screen. A suspicious operation count is incremented when the account creation has been canceled on the next item input screen. When the suspicious operation count exceeds a reference value, the account creation by the client apparatus is stopped for a specified period of time.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 illustrates a hardware configuration of an account management server according to an embodiment of the present disclosure.

FIG. 2 illustrates a functional configuration of the account management server.

FIG. 3 is a flowchart of operation performed by the account management server.

FIG. 4 illustrates an error screen.

### DETAILED DESCRIPTION OF THE EXEMPLARY EMBODIMENTS

In related art, an approach of preventing an account list from being created by not displaying specific details of errors in an error message in order not to indicate whether IDs overlap, is used. However, this may result in sacrificing convenience of users, and thus users may have no option but to find out, by trial and error, what prevents accounts from being created.

Further, the following method is also commonly used: a software service called a Web application firewall (WAF) is used so that suspicious behavior of a user is detected to be blocked using, for example, AI. However, the WAF is a comprehensive security service. Thus, the introduction of such a service for local measures for prevention of, for example, creation of an account list may result in high introduction costs or high operation costs.

In view of the circumstances described above, the present disclosure makes it possible to provide, at low costs, a configuration that prevents a malicious user from investigating a valid ID and performing an attack.

Hereinafter, embodiments of the present disclosure will be described with reference to the drawings.

### 1. Hardware Configuration of Account Management Server

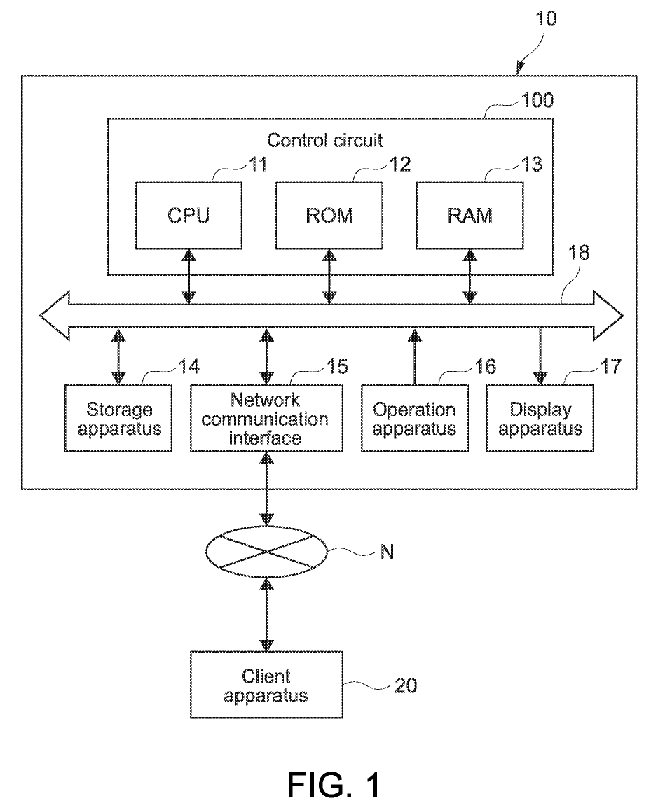

FIG. 1 illustrates a hardware configuration of an account management server according to an embodiment of the present disclosure.

An account management server 10 includes a CPU 11, a ROM 12, a RAM 13, a large-capacity nonvolatile storage apparatus 14 such as an HDD or an SSD, a network communication interface 15, an operation apparatus 16, a display apparatus 17, and a bus 18 through which those structural elements are connected to each other.

The CPU 11, the ROM 12, and the RAM 13 are included in a control circuit 100. The CPU 11 loads, into the RAM 13, an information processing program stored in the ROM 12, and executes the program. The ROM 12 permanently stores therein, for example, a program executed by the CPU 11 and data. The ROM 12 is an example of a non-transitory computer-readable recording medium.

The account management server 10 is connected to a client apparatus 20 through a network N such as the Internet. The relationship between the account management server 10 and the client apparatus 20 corresponds to a relationship between a Web server and a Web client that runs a Web browser. The client apparatus 20 may be any terminal apparatus, and may be, for example, an image forming apparatus such as a smartphone, a tablet computer, a personal computer, or a multifunction peripheral.

### 2. Functional Configuration of Account Management Server

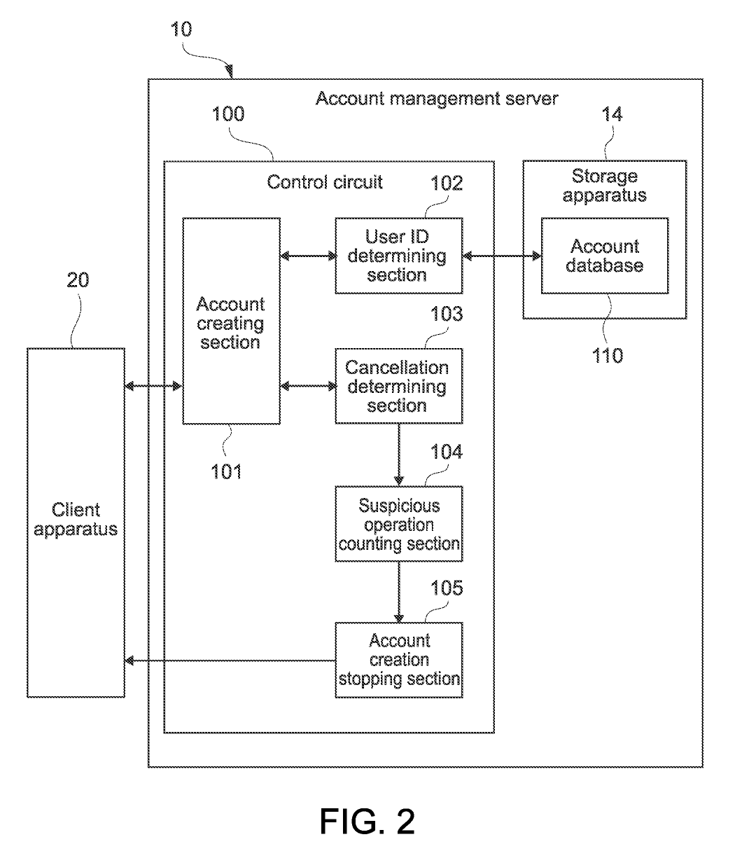

FIG. 2 illustrates a functional configuration of the account management server.

The account management server 10 operates as an account creating section 101, a user ID determining section 102, a cancellation determining section 103, a suspicious operation counting section 104, and an account creation stopping section 105 by an account management program being executed by the control circuit 100. The storage apparatus 14 holds an account database 110.

### 3. Flowchart of Operation Performed by Account Management Server

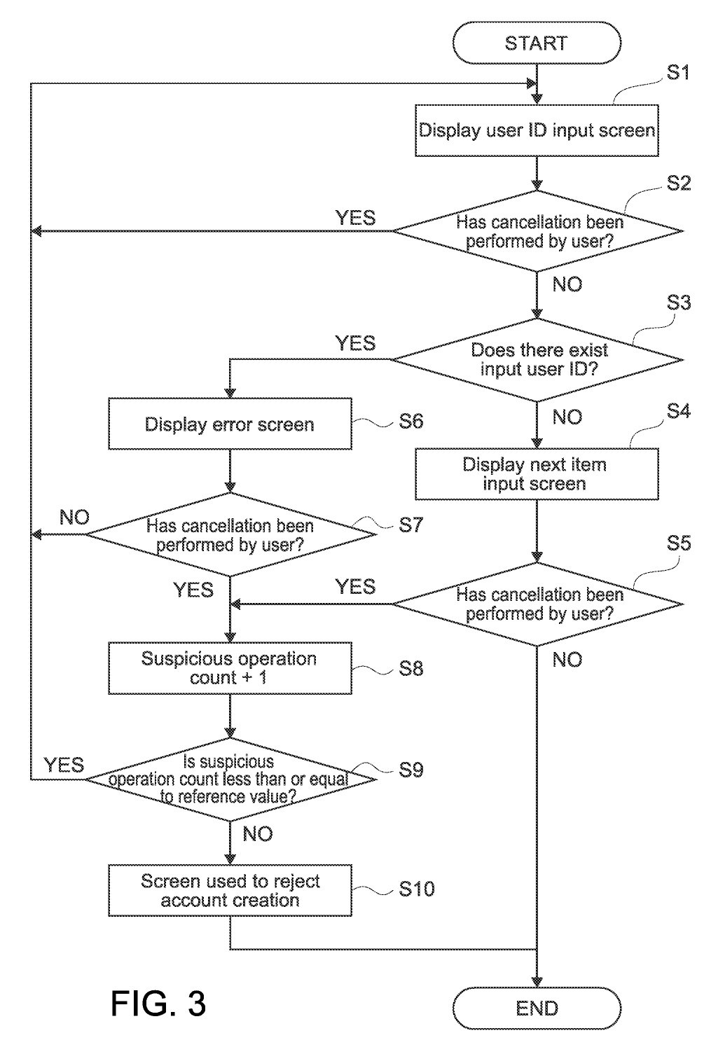

FIG. 3 is a flowchart of operation performed by the account management server.

The account creating section 101 displays a user ID input screen on the client apparatus 20 (Step S1). The user ID input screen is used to perform an account creating process on the basis of a user ID input to the user ID input screen. The user ID input screen includes an input form for, for example, a user ID and an email address that a user who creates an account wants to use. The account creating section 101 continues to perform the account creating process unless the cancellation determining section 103 detects cancellation of account creation (Step S2, NO).

The user ID determining section 102 refers to the account database 110, and determines whether the user ID input by the user to the user ID input screen displayed on the client apparatus 20 exists (Step S3). Existing account information (including user IDs, email addresses, and passwords) is registered with the account database 110.

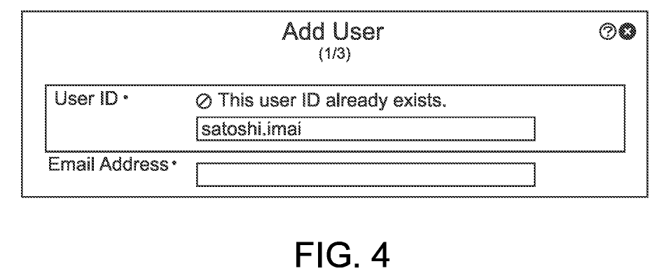

FIG. 4 illustrates an error screen.

When the user ID input by the user to the user ID input screen exists (Step S3, YES), the account creating section 101 displays an error screen on the client apparatus 20 (Step S6). For example, a message indicating "This user ID already exists." is displayed on the error screen for a text input to the user ID input form.

The account creating section 101 continues to perform the account creating process unless the cancellation determining section 103 detects cancellation of account creation (Step S7, NO). Specifically, the account creating section 101 displays the user ID input screen again on the client apparatus 20 (Step S1).

When the user ID input by the user to the user ID input screen does not exist (Step S3, NO), the account creating section 101 displays, on the client apparatus 20, a next item input screen used to input a next item such as a password (Step S4). The account creating section 101 continues to perform the account creating process unless the cancellation determining section 103 detects cancellation of account creation (Step S5, NO). The account creating process described above is a normal account creating process.

On the other hand, it is assumed that, since the user ID input by the user to the user ID input screen does not exist (Step S3, NO), the cancellation determining section 103 determines, after the next item input screen is displayed (Step S4), that the account creation has been canceled by the user on the next item input screen (Step S5, YES). The user cancels account creation on the next item input screen in spite of the fact that the user ID input by the user does not exist (that is, in spite of the fact that an account can be created). This shows that a malicious user may be trying to find out an existing account ID. Thus, the suspicious operation counting section 104 increments a suspicious operation count by one (Step S8).

Further, it is assumed that, since the user ID input by the user to the user ID input screen exists (Step S3, YES), the cancellation determining section 103 determines, after the error screen is displayed (Step S6), that the account creation has been canceled by the user on the error screen (Step S7, YES). The user cancels account creation on the error screen in spite of the fact that the user ID input by the user exists (that is, in spite of the fact that an account is to be created again). This shows that a malicious user may have achieved his/her goal to find out an existing account ID. Thus, the suspicious operation counting section 104 increments the suspicious operation count by one (Step S8).

When the suspicious operation count exceeds a reference value (several times) (Step S9, NO), the account creation stopping section 105 determines that there is an illegal operation performed to try to find out an existing account ID. Then, the screen is changed to a screen used to reject account creation by the client apparatus 20, and the account creation is stopped for a specified period of time (Step S10). On the other hand, when the suspicious operation count does not exceed the reference value (Step S9, YES), an inputting error may have occurred. Thus, returning of the process is permitted about several times as a normal operation, and the account creating section 101 continues to perform the account creating process. Specifically, the account creating section 101 displays the user ID input screen again on the client apparatus 20 (Step S1).

In related art, an approach of preventing an account list from being created by not displaying specific details of errors in an error message in order not to indicate whether IDs overlap, is used. However, this may result in sacrificing convenience of users, and thus users may have no option but to find out, by trial and error, what prevents accounts from being created.

Further, the following method is also commonly used: a software service called a Web application firewall (WAF) is used so that suspicious behavior of a user is detected to be blocked using, for example, AI. However, the WAF is a comprehensive security service. Thus, the introduction of such a service for local measures for prevention of, for example, creation of an account list may result in high introduction costs or high operation costs.

On the other hand, the present embodiment makes it possible to provide, at low costs, a configuration that prevents a malicious user from investigating a valid user ID and performing an attack.

Although each embodiment and each modified example of the present technology have been described above, the present technology is not limited to the above-mentioned embodiments, and various modifications can be made without departing from the gist of the present technology as a matter of course.

What is claimed is:

1. An account management server, comprising:
an account creating section that displays a user ID input screen on a client apparatus, the account creating section performing an account creating process on a basis of a user ID input to the user ID input screen;
a user ID determining section that determines whether the user ID input by a user to the user ID input screen exists;
a cancellation determining section that determines that account creation has been canceled by the user on a next item input screen, the determination being performed when the user ID does not exist;
a suspicious operation counting section that increments a suspicious operation count when the account creation has been canceled on the next item input screen; and
an account creation stopping section that stops the account creation by the client apparatus for a specified period of time, the stopping being performed when the suspicious operation count exceeds a reference value.

2. The account management server according to claim 1, wherein,
when the user ID exists, the cancellation determining section determines that the account creation has been canceled by the user on an error screen, and
when the account creation has been canceled on the error screen, the suspicious operation counting section increments a suspicious operation count.

3. The account management server according to claim 2, wherein,
when the account creation has not been canceled on the next item input screen or the error screen, the account creating section continues to perform the account creating process.

4. A non-transitory computer-readable recording medium that has recorded therein an account management program that causes a control circuit of an account management server to operate as an account creating section, a user ID determining section, a cancellation determining section, a suspicious operation counting section, and an account creation stopping section,
the account creating section displaying a user ID input screen on a client apparatus, the account creating section performing an account creating process on a basis of a user ID input to the user ID input screen,
the user ID determining section determining whether the user ID input by a user to the user ID input screen exists,
when the user ID does not exist, the cancellation determining section determining that account creation has been canceled by the user on a next item input screen,
the suspicious operation counting section incrementing a suspicious operation count when the account creation has been canceled on the next item input screen,
when the suspicious operation count exceeds a reference value, the account creation stopping section stopping the account creation by the client apparatus for a specified period of time.

5. An account management method that is performed by an account management program being executed by a control circuit of an account management server, the account management method comprising:
displaying a user ID input screen on a client apparatus;
performing an account creating process on a basis of a user ID input to the user ID input screen;
determining whether the user ID input by a user to the user ID input screen exists;
when the user ID does not exist, determining that account creation has been canceled by the user on a next item input screen;
incrementing a suspicious operation count when the account creation has been canceled on the next item input screen; and
when the suspicious operation count exceeds a reference value, stopping the account creation by the client apparatus for a specified period of time.
